(19) United States
(12) Patent Application Publication
(10) Pub. No.: US 2026/0342757 A1
(43) Pub. Date: Oct. 29, 2026

(54) METHOD AND APPARATUS FOR PROCESSING STATE INFORMATION, AND ELECTRONIC DEVICE

(71) Applicant: Beijing Zitiao Network Technology Co., Ltd., Beijing (CN)

(72) Inventors: Yiguo WANG, Beijing (CN); Huabin TIAN, Beijing (CN); Jiawei FAN, Beijing (CN); Pinpin LI, Beijing (CN); Chuanhao ZHAN, Beijing (CN); Wei DONG, Beijing (CN)

(21) Appl. No.: 19/107,466

(22) PCT Filed: Dec. 13, 2023
(86) PCT No.: PCT/CN2023/138348

§ 371 Date: Feb. 27, 2025

(30) Foreign Application Priority Data
Jan. 31, 2023 (CN) 202310119271.8
Jan. 31, 2023 (CN) 202310119289.8

(51) Int. Cl. H04L 51/043; G06F 3/0483; H04L 51/216

(52) U.S. Cl. CPC H04L 51/043; H04L 51/216; G06F 3/0483; G06F 2203/04803

(57) ABSTRACT

A method, a storage medium and an electronic device for processing state information are provided. The method includes: in response to a chat triggering operation for a chat object, determining whether the chat object is set with a state; and in response to the chat object being set with the state, displaying the state of the chat object in a chat interface.

The present disclosure claims priority to Chinese Patent Application No. 202310119271.8, filed on Jan. 31, 2023, and Chinese Patent Application No. 202310119289.8, filed on Jan. 31, 2023, and the entire content disclosed by the Chinese patent applications is incorporated herein by reference as part of the present disclosure.

### TECHNICAL FIELD

Embodiments of the present disclosure relate to a method and an apparatus for processing state information, and an electronic device.

### BACKGROUND

With the continuous development of computer software technology and Internet technology, instant messaging tools are increasingly applied in people's work and life. Instant messaging tools have a group chat function, through which people can communicate with contacts or chat with group members in a group to discuss issues or notify messages. Moreover, other group members may be further mentioned in the group for a targeted chat. Before communicating with a contact or chatting with a group member to be mentioned in the group, people usually expect to know a state of the contact or the group member to avoid unnecessary disturbance. Therefore, there is a need for a solution to process state information.

### SUMMARY

The present disclosure provides a method and an apparatus for processing state information, and an electronic device.

According to a first aspect, a method for processing state information is provided, and the method includes:
in response to a preset operation of mentioning a first member by a user in a group chat, determining whether the first member is set with a state; and
in response to the first member being set with a first state, displaying first state information corresponding to the first member in a target region of a chat interface of the group chat.

According to a second aspect, an apparatus for processing state information is provided, and the apparatus includes:
a determination module configured to, in response to a preset operation of mentioning a first member by a user in a group chat, determine whether the first member is set with a state; and
a display module configured to, in response to the first member being set with a first state, display first state information corresponding to the first member in a target region of a chat interface of the group chat.

According to a third aspect, a method for processing state information is provided, and the method includes:
in response to entering a target chat interface corresponding to a target contact, determining whether the target contact is set with a state;
in response to the target contact being set with a target state, displaying the target state in the target chat interface; and
displaying a target state description corresponding to the target state in the target chat interface, where the target state description is preset for the target state.

According to a fourth aspect, an apparatus for processing state information is provided, and the apparatus includes:
a determination module configured to, in response to entering a target chat interface corresponding to a target contact, determine whether the target contact is set with a state;
a first display module configured to, in response to the target contact being set with a target state, display the target state in the target chat interface; and
a second display module configured to, display a target state description corresponding to the target state in the target chat interface, where the target state description is preset for the target state.

According to a fifth aspect, a computer-readable storage medium is provided, and a computer program is stored in the storage medium, and when the computer program is executed by a processor, the method according to any one of the first aspect and the third aspect is implemented.

According to a sixth aspect, an electronic device is provided, including a memory, a processor, and a computer program stored in the memory and executable on the processor, and when the processor executes the program, the method according to any one of the first aspect and the third aspect is implemented.

It should be understood that the above general description and the following detailed description are only exemplary and explanatory, and cannot limit the present disclosure.

### BRIEF DESCRIPTION OF DRAWINGS

In order to more clearly explain the technical solutions in the embodiments of the present disclosure, the drawings that need to be used in the description of the embodiments will be briefly introduced below. Obviously, the drawings in the following description are only some embodiments recorded in the present disclosure. For those of ordinary skill in the art, other drawings may be obtained based on these drawings without creative efforts.

FIG. 1a1 is a schematic diagram of a chat interface of an instant messaging client according to an exemplary embodiment of the present disclosure;

FIG. 1a2 is a schematic diagram of another chat interface of an instant messaging client according to an exemplary embodiment of the present disclosure;

FIG. 1b1 is a schematic diagram of another chat interface of an instant messaging client according to an exemplary embodiment of the present disclosure;

FIG. 1b2 is a schematic diagram of another chat interface of an instant messaging client according to an exemplary embodiment of the present disclosure;

FIG. 1c1 is a schematic diagram of another chat interface of an instant messaging client according to an exemplary embodiment of the present disclosure;

FIG. 1c2 is a schematic diagram of another chat interface of an instant messaging client according to an exemplary embodiment of the present disclosure;

FIG. 1d1 is a schematic diagram of another chat interface of an instant messaging client according to an exemplary embodiment of the present disclosure;

FIG. 1d2 is a schematic diagram of another chat interface of an instant messaging client according to an exemplary embodiment of the present disclosure;

FIG. 1e1 is a schematic diagram of another chat interface of an instant messaging client according to an exemplary embodiment of the present disclosure;

FIG. 1e2 is a schematic diagram of another chat interface of an instant messaging client according to an exemplary embodiment of the present disclosure;

FIG. 2 is a flowchart of a method for processing state information according to an exemplary embodiment of the present disclosure;

FIG. 3 is a block diagram of an apparatus for processing state information according to an exemplary embodiment of the present disclosure;

FIG. 4a1 is a schematic diagram of a chat interface of an instant messaging client according to an exemplary embodiment of the present disclosure;

FIG. 4a2 is a schematic diagram of another chat interface of an instant messaging client according to an exemplary embodiment of the present disclosure;

FIG. 4b1 is a schematic diagram of another chat interface of an instant messaging client according to an exemplary embodiment of the present disclosure;

FIG. 4b2 is a schematic diagram of another chat interface of an instant messaging client according to an exemplary embodiment of the present disclosure;

FIG. 4c1 is a schematic diagram of another chat interface of an instant messaging client according to an exemplary embodiment of the present disclosure;

FIG. 4c2 is a schematic diagram of another chat interface of an instant messaging client according to an exemplary embodiment of the present disclosure;

FIG. 4d1 is a schematic diagram of another chat interface of an instant messaging client according to an exemplary embodiment of the present disclosure;

FIG. 4d2 is a schematic diagram of another chat interface of an instant messaging client according to an exemplary embodiment of the present disclosure;

FIG. 4e1 is a schematic diagram of another chat interface of an instant messaging client according to an exemplary embodiment of the present disclosure;

FIG. 4e2 is a schematic diagram of another chat interface of an instant messaging client according to an exemplary embodiment of the present disclosure;

FIG. 5 is a flowchart of a method for processing state information according to an exemplary embodiment of the present disclosure;

FIG. 6A is a flowchart of another method for processing state information according to an exemplary embodiment of the present disclosure;

FIG. 6B and FIG. 6C are schematic diagrams of a state setting page according to an exemplary embodiment of the present disclosure;

FIG. 6D and FIG. 6E are schematic diagrams of another state setting page according to an exemplary embodiment of the present disclosure;

FIG. 7 is a block diagram of an apparatus for processing state information according to an exemplary embodiment of the present disclosure;

FIG. 8 is a schematic block diagram of an electronic device according to some embodiments of the present disclosure;

FIG. 9 is a schematic block diagram of another electronic device according to some embodiments of the present disclosure; and

FIG. 10 is a schematic diagram of a storage medium according to some embodiments of the present disclosure.

### DETAILED DESCRIPTION

In order to enable those skilled in the art to better understand the technical solutions in the present disclosure, the technical solutions in the embodiments of the present disclosure will be clearly and completely described below with reference to the drawings in the embodiments of the present disclosure. Obviously, the described embodiments are only a part of the embodiments of the present disclosure, rather than all the embodiments. All other embodiments obtained by those of ordinary skill in the art based on the embodiments of the present disclosure without creative efforts shall fall within the protection scope of the present disclosure.

When the following description refers to the drawings, the same numbers in different drawings represent the same or similar elements, unless otherwise indicated. The implementations described in the following exemplary embodiments do not represent all implementations consistent with the present disclosure. Rather, they are merely examples of apparatuses and methods consistent with some aspects of the present disclosure as detailed in the appended claims.

The terms used in the present disclosure are only for the purpose of describing specific embodiments, and are not intended to limit the present disclosure. The singular forms “a”, “an” and “the” used in the present disclosure are also intended to include the plural forms, unless the context clearly indicates other meanings. It should also be understood that the term “and/or” used herein refers to and includes any or all possible combinations of one or more associated listed items.

It should be understood that although various information may be described in the present disclosure by using terms such as first, second, and third, the information should not be limited to these terms. These terms are only used to distinguish one type of information from another type of information. For example, the first information may also be called the second information without departing from the scope of the present disclosure. Similarly, the second information may also be called the first information. Depending on the context, the word “if” as used herein may be interpreted as “when”, “while” or “in response to determining”.

With the continuous development of computer software technology and Internet technology, instant messaging tools are increasingly applied in people's work and life. People can communicate with a chat object through the instant messaging tools to discuss issues or notify messages. When communicating with the chat object, people usually expect to know a state of the chat object in time, so as to avoid unnecessary disturbance while the chat object is in a special state (for example, on vacation, in a meeting, or driving, etc.).

At least one embodiment of the present disclosure provides a method for processing state information, and the method includes: in response to a chat triggering operation for a chat object, determining whether the chat object is set with a state; and in response to the chat object being set with the state, displaying the state of the chat object in a chat interface.

For example, in some embodiments, the chat object includes a group member of a group chat. The in response to a chat triggering operation for a chat object, determining whether the chat object is set with a state includes: in response to a preset operation of mentioning a first member by a user in the group chat, determining whether the first member is set with a state, where the chat object includes the first member in the group chat, and the chat triggering operation includes the preset operation of mentioning the first member by the user in the group chat. The in response to the chat object being set with the state, displaying the state of the chat object in a chat interface includes: in response to the first member being set with a first state, displaying first state information corresponding to the first member in a target region of a chat interface of the group chat.

For example, in some embodiments, the chat object includes an individual contact. The in response to a chat triggering operation for a chat object, determining whether the chat object is set with a state includes: in response to entering a target chat interface corresponding to a target contact, determining whether the target contact is set with a state, where the chat object includes the target contact, and the chat triggering operation includes an operation of entering the target chat interface corresponding to the target contact. The in response to the chat object being set with the state, displaying the state of the chat object in a chat interface includes: in response to the target contact being set with a target state, displaying the target state in the target chat interface; and displaying a target state description corresponding to the target state in the target chat interface, where the target state description is preset for the target state.

At least one embodiment of the present disclosure further provides an apparatus for processing state information, and the apparatus includes a determination module and a display module. The determination module is configured to, in response to a chat triggering operation for a chat object, determine whether the chat object is set with a state, and the display module is configured to, in response to the chat object being set with the state, display the state of the chat object in a chat interface.

For example, in some embodiments, the chat object includes a group member of a group chat. When executing the in response to a chat triggering operation for a chat object, determining whether the chat object is set with a state, the determination module is configured to: in response to a preset operation of mentioning a first member by a user in the group chat, determine whether the first member is set with a state, where the chat object includes the first member in the group chat, and the chat triggering operation includes the preset operation of mentioning the first member by the user in the group chat. When executing the in response to the chat object being set with the state, displaying the state of the chat object in a chat interface, the display module is configured to: in response to the first member being set with a first state, display first state information corresponding to the first member in a target region of a chat interface of the group chat.

For example, in some embodiments, the chat object includes an individual contact. When executing the in response to a chat triggering operation for a chat object, determining whether the chat object is set with a state, the determination module is configured to: in response to entering a target chat interface corresponding to a target contact, determine whether the target contact is set with a state, where the chat object includes the target contact, and the chat triggering operation includes an operation of entering the target chat interface corresponding to the target contact. The display module includes a first display module and a second display module, the first display module is configured to: in response to the target contact being set with a target state, display the target state in the target chat interface. The second display module is configured to: display a target state description corresponding to the target state in the target chat interface, where the target state description is preset for the target state.

These embodiments of the present disclosure enable a user to view state information of the chat object more conveniently and quickly without disturbing the chat object, and improve user experience.

For example, an instant messaging tool has a group chat function, and a group includes a plurality of group members. When people want to communicate with a specific group member (a chat object in the present disclosure) in the group, they can have a targeted chat with the specific group member by triggering operations such as mentioning other group members, etc. Before chatting with a group member to be mentioned in the group, people usually expect to know a state of the group member to avoid unnecessary disturbance while the group member is in a special state (for example, on vacation, in a meeting, or driving, etc.). At present, a user can only click an avatar of the group member to enter a personal information page of the group member, and search for state information of the group member from the personal information page, so as to chat with the group member at an appropriate time. In the following, the chat object including the group member of the group chat is taken as an example for description. In this embodiment, the chat object may include at least one member in the group chat, such as a first member and a second member described below. Therefore, the chat triggering operation may include a preset operation of mentioning the first member by the user in the group chat, and may also include a preset operation of mentioning the second member by the user in the group chat.

Some embodiments of the present disclosure provide a method for processing state information. After a group member is mentioned by a user in a group chat, whether the group member is set with a state is determined, and if the group member is set with a first state, first state information corresponding to the group member is displayed in a target region of a chat interface of the group chat. This allows the user to view the state information of the group member to be mentioned more conveniently and quickly without disturbing the group member and other group members, providing a more targeted manner of state information prompting for the user, thereby enhancing user experience.

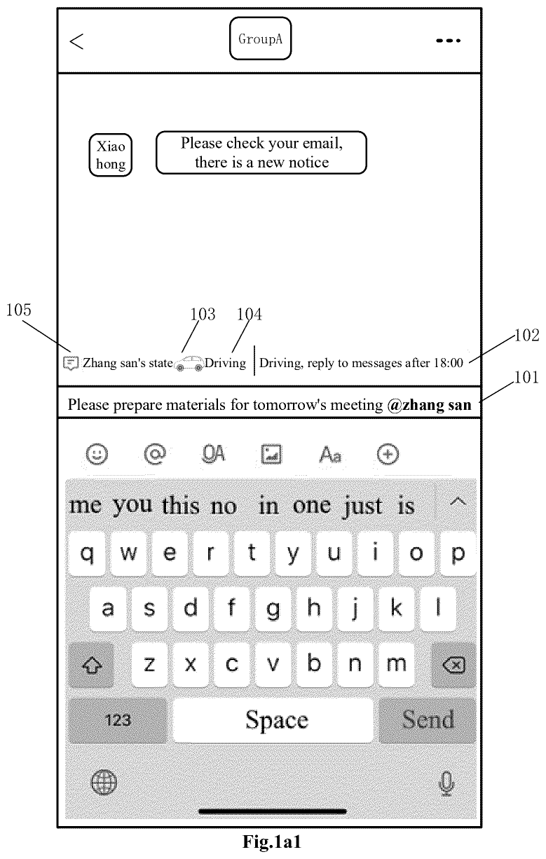

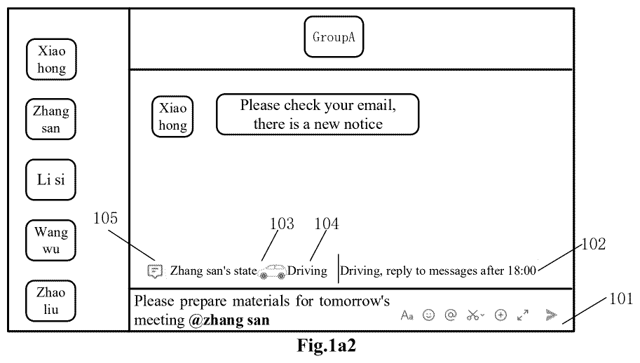

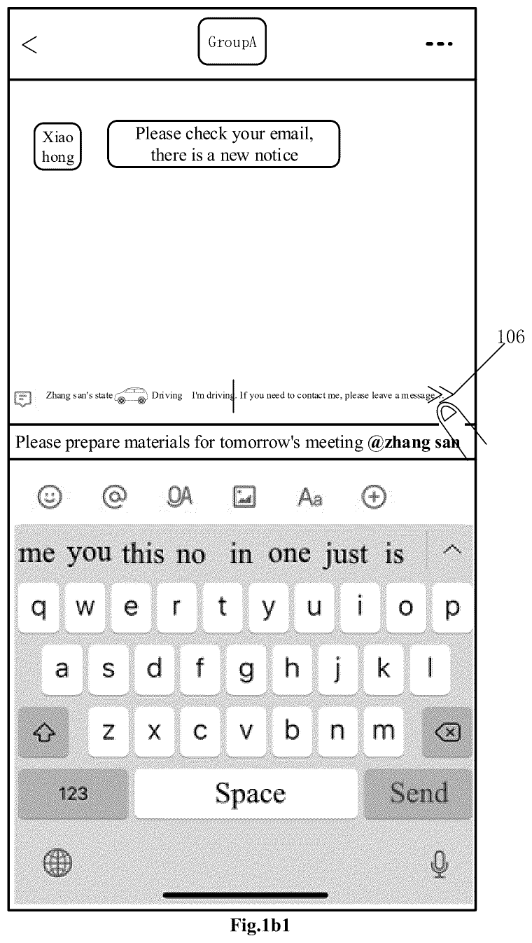

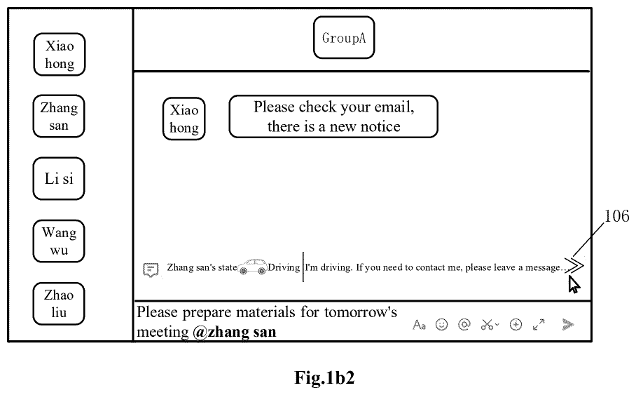

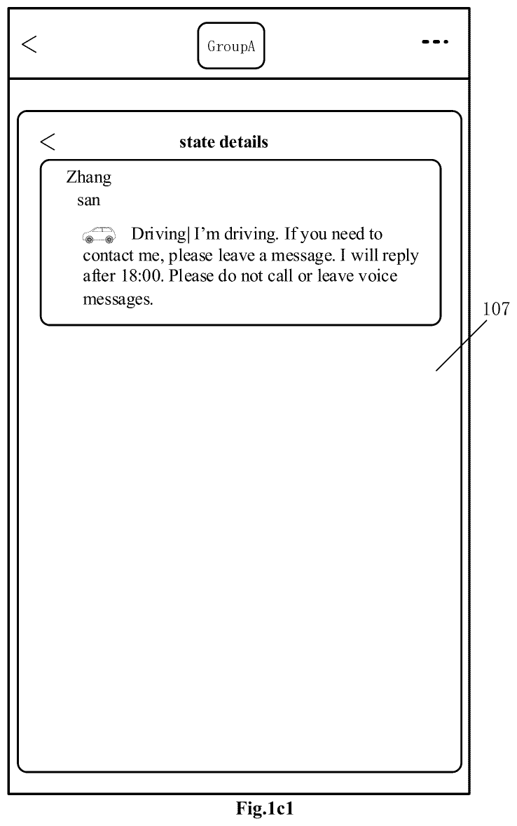

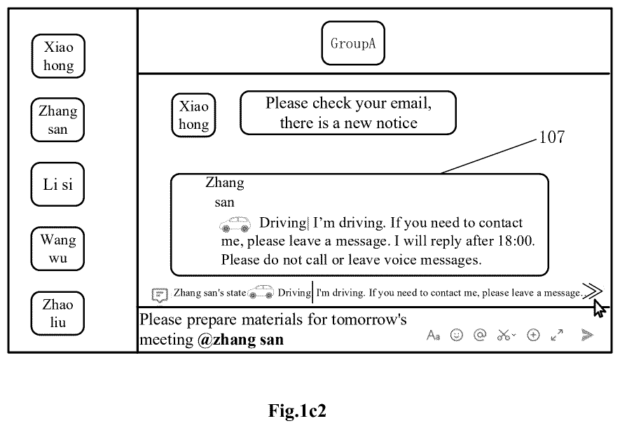

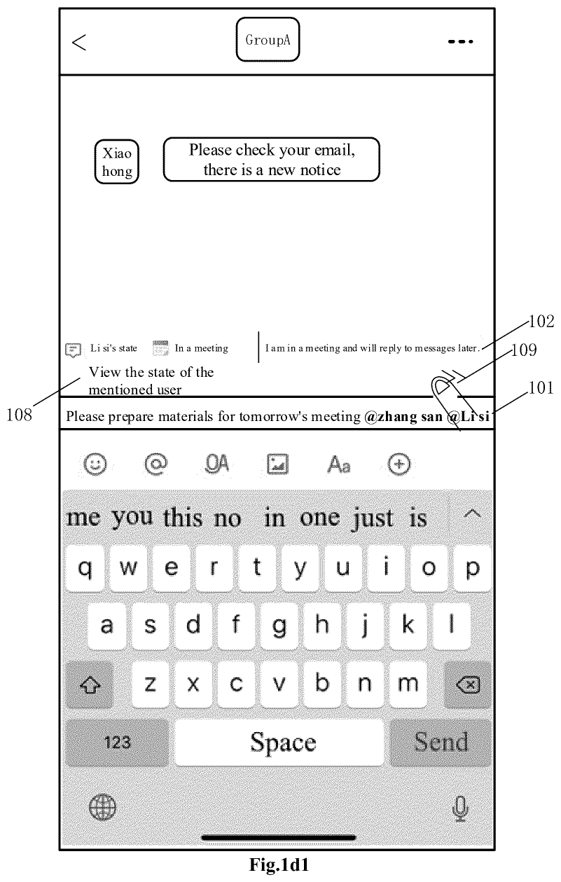

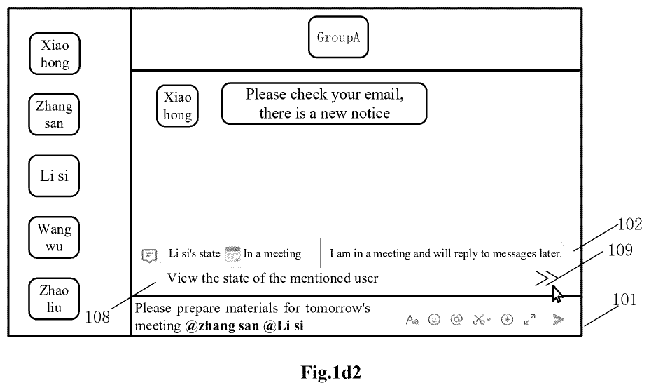

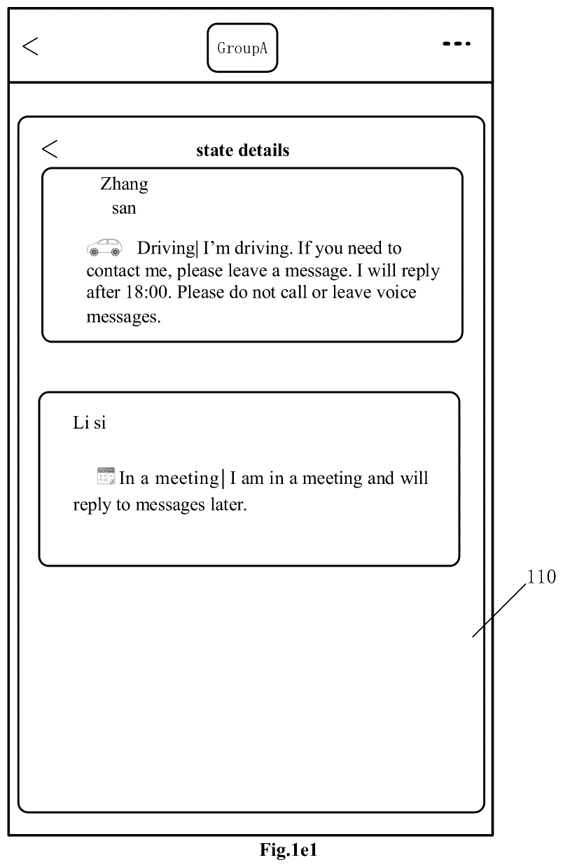

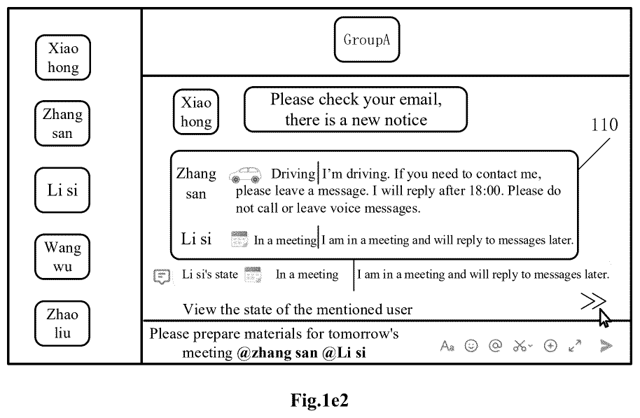

FIG. 1a1 and FIG. 1a2 are schematic diagrams of a chat interface of an instant messaging client according to an exemplary embodiment (FIG. 1a1 corresponds to a mobile terminal interface, and FIG. 1a2 corresponds to a PC terminal interface). As shown in FIG. 1a1 and FIG. 1a2, a user who logs in to the instant messaging client is a group member of a group named group A. After entering a group chat of the group A, the user can perform an operation of mentioning a group member Zhang San in the group chat. For example, a combination of a character “@” and a member identifier “Zhang San” of the group member Zhang San, that is, “@Zhang San”, can be input in a message input box 101 of the group chat. It should be noted that in the present disclosure, the message input box of the group chat is located above the chat interface of the group chat.

After the operation of mentioning the group member Zhang San is completed, the instant messaging client determines whether the group member Zhang San is set with a state, and if Zhang San is set with a state, state information corresponding to the group member Zhang San may be displayed in the chat interface of the group chat. The state information may include at least the above-mentioned state set by Zhang San, for example, the state may be “driving”, and the state may be displayed in the chat interface of the group chat. As shown in FIG. 1a1 and FIG. 1a2, the state may be specifically displayed in a region 102 above the message input box in the chat interface. For example, an icon 103 corresponding to the state is displayed and text content 104 corresponding to the state is displayed.

Optionally, the state information may further include a state description preset by the group member Zhang San, for example, the state description is “Driving, reply to messages after 18:00”. As shown in FIG. 1a1 and FIG. 1a2, the state description may be displayed behind the state displayed in the region 102.

It should be noted that if the content of the state information to be displayed in the region 102 is not long, and an area of a region required for displaying the state information is smaller than an area of the region 102, all content of the state information may be directly displayed in the region 102. As shown in FIG. 1b1 and FIG. 1b2 (FIG. 1b1 corresponds to a mobile terminal interface, and FIG. 1b2 corresponds to a PC terminal interface), if the content of the state description in the state information to be displayed is too long (resulting in the content of the state information being too long), for example, the content of the state description includes “I'm driving. If you need to contact me, please leave a message. I will reply after 18:00. Please do not call or leave voice messages”, and the area of the region required for displaying the state information including the state description is greater than the area of the region 102, a part of content of the state information may be displayed in the region 102, that is, a part of content of the state description is displayed. For example, only“ I'm driving. If you need to contact me, please leave a message ...” may be displayed in the region 102. A guidance icon 106 may be displayed behind the displayed state information to guide the user to view the full content of the state information by triggering the guidance icon 106.

Specifically, the triggering operation for viewing the full content of the state information may be to click the content of the state information displayed in the region 102, or to click the guidance icon 106, etc. The specific manner of the triggering operation is not limited in this embodiment. As shown in Fig. 1c1 and FIG. 1c2 (FIG. 1c1 corresponds to a mobile terminal interface, and FIG. 1c2 corresponds to a PC terminal interface), after the user performs the triggering operation, a details page 107 may be output, and the full content of the state information is displayed in the details page 107.

In addition, an icon indicating the state may be displayed in front of the displayed state information. As shown in FIG. 1a1 and FIG. 1a2, an icon 105 may be displayed in front of the state information displayed in the region 102, and the icon 105 may be used to indicate that the information displayed behind the icon 105 is the state information.

In one case, if the user only needs to mention one group member Zhang San, the state information corresponding to Zhang San displayed in the region 102 is eliminated after the user sends the message in the message input box. In another case, if the user deletes “@Zhang San” from the message input box, the state information corresponding to Zhang San displayed in the region 102 also needs to be eliminated. In yet another case, if the user also needs to mention other group members at the same time, for example, Li Si also needs to be mentioned, as shown in FIG. 1d1 and FIG. 1d2, the user may also input a combination “@Li Si” in the message input box 101 of the group chat to complete an operation of mentioning the group member Li Si. The instant messaging client determines whether the group member Li Si is set with a state, and if Li Si is set with a state, the state information corresponding to Zhang San displayed in the chat interface of the group chat may be updated to state information corresponding to Li Si. Specifically, for example, the state information corresponding to Li Si includes a state “in a meeting” and a state description “I am in a meeting and will reply to messages later” . The state information may be displayed in the region 102 above the message input box in the chat interface.

Optionally, a guidance region in which guidance information is displayed may be output in the above-mentioned chat interface. As shown in FIG. 1d1 and FIG. 1d2 (FIG. 1d1 corresponds to a mobile terminal interface, and FIG. 1d2 corresponds to a PC terminal interface), for example, the guidance information may be “view the state of the mentioned user”, and the guidance information may be displayed in a guidance region 108 above the message input box 101 in the chat interface. When the user triggers the guidance information, a details page may be output. A guidance icon 109 may also be displayed behind the displayed guidance information to guide the user to enter the details page through an operation of triggering the guidance icon 109. As shown in FIG. 1e1 and FIG. 1e2 (FIG. 1e1 corresponds to a mobile terminal interface, and FIG. 1e2 corresponds to a PC terminal interface), after the user performs the triggering operation, a details page 110 may be output, and the full content of the state information corresponding to Zhang San and the full content of the state information corresponding to Li Si are displayed in the details page 110.

In the solution provided in this embodiment, after a group member is mentioned by a user in a group chat, whether the group member is set with a state is determined, and if the group member is set with a state, state information corresponding to the group member is displayed in a target region of a chat interface of the group chat. This allows the user to view the state information of the mentioned group member more conveniently and quickly without disturbing the group member and other group members, providing a more targeted manner of state information prompting for the user, thereby enhancing user experience.

Further, in the group chat, since the user needs to mention the group member through the message input box and input the message to be sent, displaying the state information corresponding to the mentioned group member above the message input box in the chat interface can enable the user to view the state information of the group member more conveniently and quickly, thereby further expanding a function of the instant messaging client and enhancing user experience.

Still further, after the user performs a triggering operation for the state information, a details page is output and full content of the state information is displayed in the details page, thereby providing a more flexible manner of displaying the state information and further enhancing user experience.

Still further, if the user mentions multiple group members, state information of a group member which is mentioned latest may be displayed in the chat interface, so as to avoid occupying too many regions of the chat interface due to simultaneously displaying state information of the plurality of group members, thereby further enhancing user experience.

Still further, a target icon indicating the state is displayed in front of the state information, so that the user can quickly locate the state information, making the information displayed in the chat interface richer, which is beneficial to enhancing user experience.

The present disclosure will be described in detail below with reference to specific embodiments.

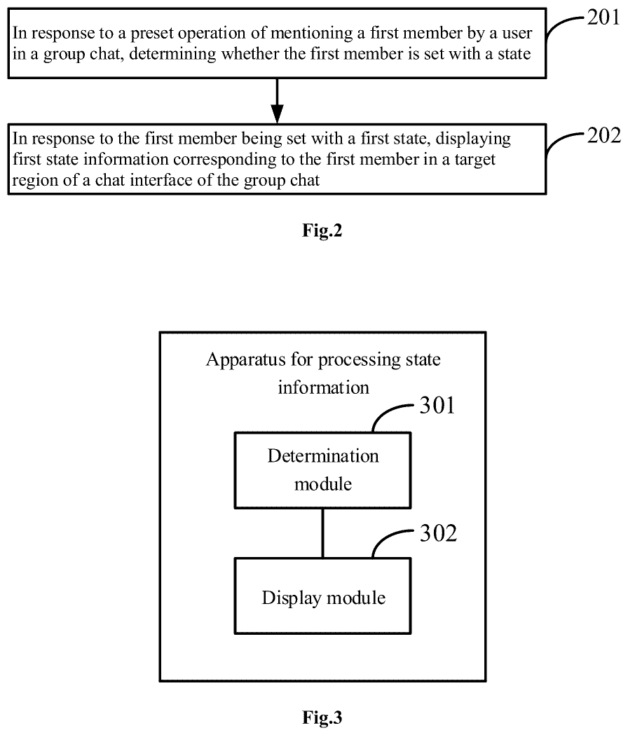

FIG. 2 is a flowchart of a method for processing state information according to an exemplary embodiment. The method may be applied to a terminal device. In this embodiment, for ease of understanding, an example will be described below in combination with a terminal device on which an instant messaging client can be installed. Those skilled in the art can understand that the terminal device may include, but is not limited to, a mobile terminal device such as a smart phone and a tablet computer, a laptop computer, a desktop computer, and the like. The method may include the following steps.

As shown in FIG. 2, in step 201, in response to a preset operation of mentioning a first member by a user in a group chat, it is determined whether the first member is set with a state.

In this embodiment, the group chat may be a chat corresponding to a group which the user joins in the instant messaging client, and the user may exchange messages with or make a call to members in the group through a chat interface of the group chat. The user may mention any group member in the group chat. For example, the user may mention the first member through the preset operation of mentioning the first member in the group chat. Optionally, the preset operation of mentioning the first member may be inputting a combination of a preset character and a member identifier of the first member in a message input box of the group chat. For example, the preset character may be the character “@” or the character “#”. It can be understood that the specific setting of the preset character is not limited in this embodiment. The member identifier of the first member may be a name of the first member or a nickname of the first member in the group, and the specific setting of the member identifier of the first member is not limited in this embodiment.

After the first member is mentioned by the user in the group chat, the instant messaging client may first determine whether the first member is set with a state. Specifically, in an implementation, the instant messaging client may send a state query request to a server to instruct the server to query whether the first member is set with a state, and in response to the first member being set with a first state, the first state is returned to the instant messaging client. In another implementation, after the instant messaging client is logged in by the user, a chat information set may be acquired from the server and the chat information set is continuously updated. The chat information set may include latest state information corresponding to each group member in each group where the user is located. The instant messaging client may query, from the chat information set, whether the first member is set with a state, and in response to the first member being set with a first state, the first state is acquired from the chat information set.

In step 202, in response to the first member being set with a first state, first state information corresponding to the first member is displayed in a target region of a chat interface of the group chat.

In this embodiment, in response to the first member being set with a state (the state is specifically a first state, where the first state refers to a specific state), first state information corresponding to the first member may be displayed in the target region of the chat interface of the group chat. For example, the first state information corresponding to the first member may be displayed between a message input box and a chat message display region in the chat interface (see FIG. 1a1 and FIG. 1a2).

In an implementation, the first state information may include a first state, and displaying the first state information includes displaying the first state, where displaying the first state may be displaying a state icon corresponding to the first state, or displaying text content corresponding to the first state, or displaying the state icon corresponding to the first state and the text content corresponding to the first state at the same time.

In another implementation, the first state information may include a first state and a state description of the first member, and displaying the first state information includes not only displaying the first state, but also displaying the state description of the first member. The state description of the first member may be a state description preset by the first member for multiple states. Therefore, the state description of the first member corresponds to the multiple states.

In yet another implementation, the first state information may include a first state and a first state description corresponding to the first state. Displaying the first state information includes not only displaying the first state, but also displaying the first state description corresponding to the first state. The first state description is a state description preset by the first member for the first state (a user may preset different state descriptions for different states in advance), and therefore, the first state description corresponds to the first state. The first state description may be a supplementary description of the first state by the first member and includes more additional information about the first state.

It should be noted that in response to an area of a region required for displaying the first state information being greater than an area of a target region, a part of content of the first state information may be displayed in the target region, and remaining content of the first state information may be hidden (see FIG. 1b1 and FIG. 1b2). Optionally, in response to an operation of triggering the target region by the user, a first details page may be output, and details content of the first state information is displayed in the first details page (see FIG. 1c1 and FIG. 1c2). The operation of triggering the target region may be an operation of clicking a display area of the first state information, or an operation of hovering a mouse over the display area of the first state information, etc., and the specific manner of the operation of triggering the target region is not limited in this embodiment.

Optionally, the first state information displayed in the target region is eliminated after content in the message input box is cleared. The content in the message input box being cleared may include sending a message from the message input box, or may include deleting the message from the message input box.

Further optionally, after the first state information is displayed, if the user performs a preset operation of mentioning a second member in the group chat, the instant messaging client may determine whether the second member is set with a state. If the second member is set with a second state, the first state information displayed in the target region is updated to second state information corresponding to the second member. The second member is a member in the group members other than the first member, and the preset operation of mentioning the second member may be inputting a combination of a preset character and a member identifier of the second member in the message input box of the group chat.

Further optionally, after the second state information is displayed, a guidance region in which guidance information is displayed may be output in the chat interface (see FIG. 1d1 and FIG. 1d2). After the guidance region is triggered by the user, a second details page may be output (see FIG. 1e1 and FIG. 1e2), and the first state information and the second state information are displayed in the second details page. It should be noted that the first details page and the second details page involved in this embodiment may represent the same page or different pages, which is not limited in this embodiment.

Still further, a target icon indicating a state is displayed in front of the first state information or the second state information in the target region. For example, a target icon indicating the first state is displayed in front of the first state information, and a target icon indicating the second state is displayed in front of the second state information. For example, the first state information and the second state information may be the same or different, which is not specifically limited in the present disclosure.

The present disclosure provides a method for processing state information. After a first member is mentioned by a user in a group chat, whether the first member is set with a state is determined, and in response to the first member being set with a first state, first state information corresponding to the first member is displayed in a target region of a chat interface of the group chat. This allows the user to view the state information of the group member to be mentioned more conveniently and quickly without disturbing the group member, providing a more targeted manner of state information prompting, thereby enhancing user experience.

It should be noted that although the operations of the method of the embodiments of the present disclosure are described in a specific order in the above embodiments, this does not require or imply that these operations must be performed in this specific order, or that all the illustrated operations must be performed to achieve a desired result. Rather, the steps depicted in the flowcharts may be performed in a different order. Additionally or alternatively, some steps may be omitted, multiple steps may be combined into one step for execution, and/or one step may be decomposed into multiple steps for execution.

Corresponding to the foregoing embodiments of the method for processing state information, the present disclosure further provides embodiments of an apparatus for processing state information.

As shown in FIG. 3, FIG. 3 is a block diagram of an apparatus for processing state information according to an exemplary embodiment of the present disclosure. The apparatus may include: a determination module 301 and a display module 302.

The determination module 301 is configured to, in response to a preset operation of mentioning a first member by a user in a group chat, determine whether the first member is set with a state.

The display module 302 is configured to, in response to the first member being set with a first state, display first state information corresponding to the first member in a target region of a chat interface of the group chat.

In some implementations, the preset operation of mentioning the first member in the group chat includes inputting a combination of a preset character and a member identifier of the first member in a message input box of the group chat.

In some other implementations, the apparatus may further include: an elimination module (not shown in the figure).

The elimination module is configured to eliminate the first state information displayed in the target region after the content in the message input box is cleared.

In some other implementations, the target region is between the message input box and the chat message display region in the chat interface.

In some other implementations, the first state information may include the first state. Alternatively, the first state information may include the first state and the state description of the first member. Alternatively, the first state information may include the first state and the first state description corresponding to the first state, where the first state description is preset for the first state.

In some other implementations, the display module 302 is configured to: in response to an area of a region required for displaying the first state information being greater than an area of the target region, display a part of content of the first state information in the target region.

In some other implementations, the apparatus may further include: a first output module (not shown in the figure).

The first output module is configured to, in response to an operation of triggering the target region by the user, output a first details page, where details content of the first state information is displayed in the first details page.

In some other implementations, the apparatus may further include: an update module (not shown in the figure).

The update module is configured to, in response to a preset operation of mentioning a second member by the user in the group chat, in response to the second member being set with a second state, update the first state information displayed in the target region to second state information corresponding to the second member.

In some other implementations, the apparatus may further include: a guidance module and a second output module (not shown in the figure).

The guidance module is configured to output, in the chat interface, a guidance region in which guidance information is displayed.

The second output module is configured to, in response to triggering the guidance region by the user, output a second details page, where the first state information and the second state information are displayed in the second details page.

In some other implementations, the apparatus may further include: an icon display module (not shown in the figure).

The icon display module is configured to display a target icon indicating a state in front of the state information in the target region.

The chat object including an individual contact will be described below as an example. In this embodiment, the chat object may include a target contact, and therefore, the chat triggering operation includes an operation of entering a target chat interface corresponding to the target contact.

In addition to communicating with group members in the group, people can also communicate directly with contacts (chat objects in the present disclosure) through instant messaging tools.

At present, a user can view a state of a contact from a contact list of an instant messaging client (for example, the contact can select an appropriate state from a plurality of alternative states provided by the instant messaging client in advance to set), so as to chat with the contact at an appropriate time.

However, it is difficult for the user to know more additional information of the contact through the contact list.

The present disclosure provides a method for processing state information. After a chat interface corresponding to a contact is entered, in response to the contact being set with a target state, the target state is displayed in the chat interface, and a target state description corresponding to the target state is displayed in the chat interface, where the target state description is preset by the contact for the target state. This allows the user to view richer additional information preset by the contact for the state of the contact more comprehensively without disturbing the contact, thereby enhancing user experience.

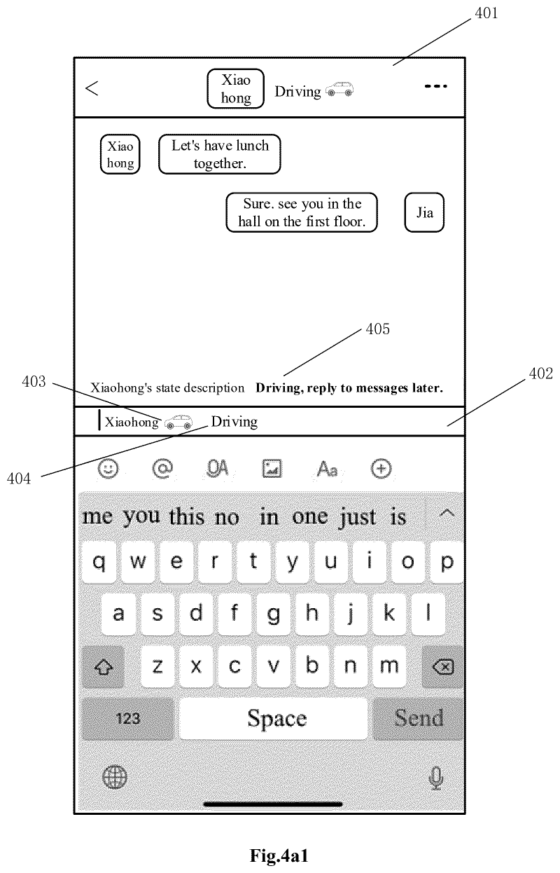

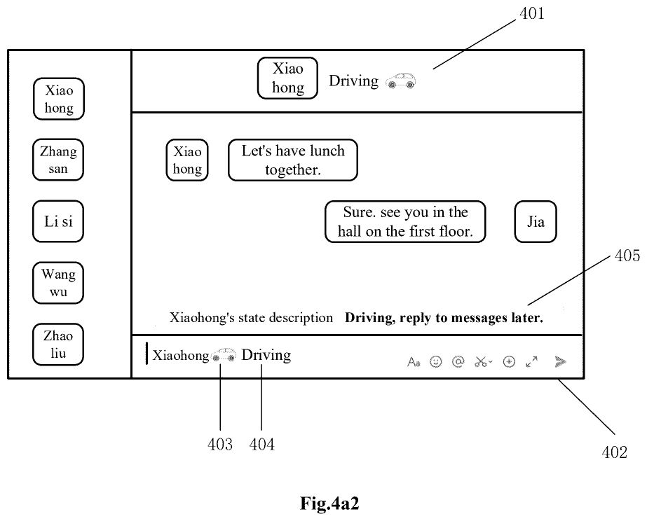

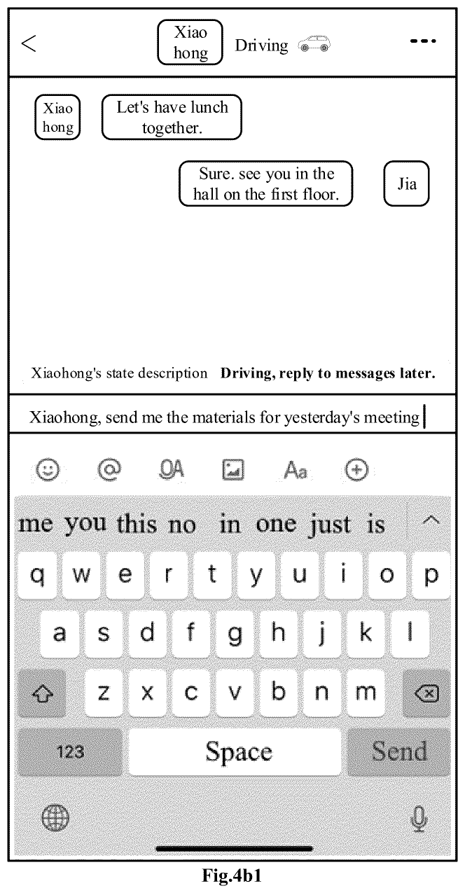

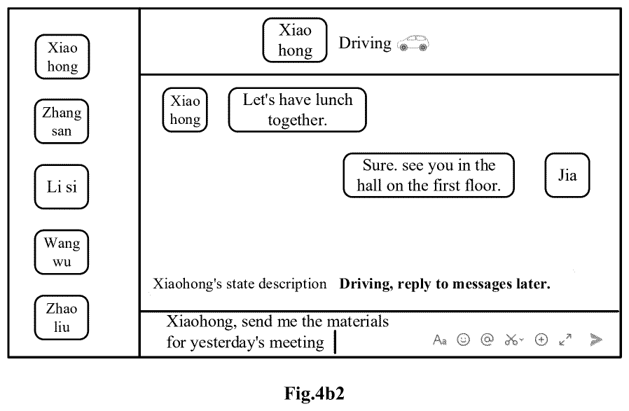

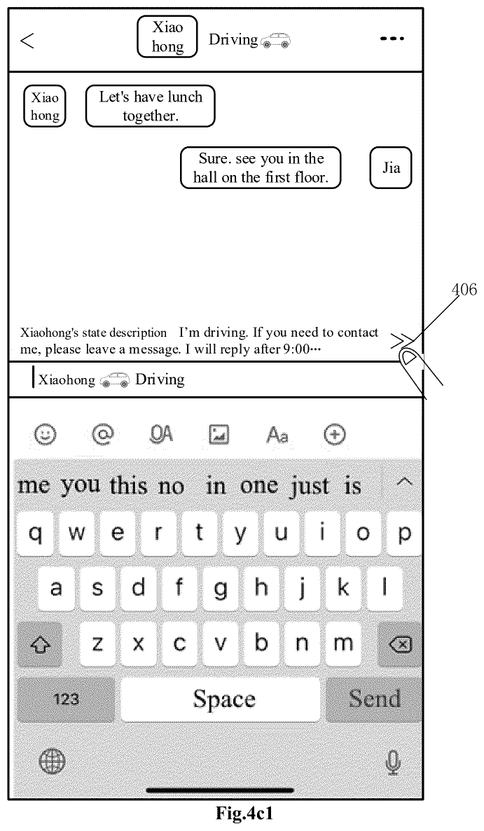

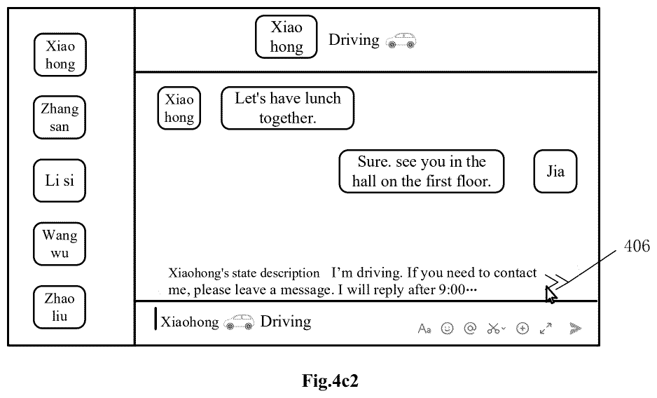

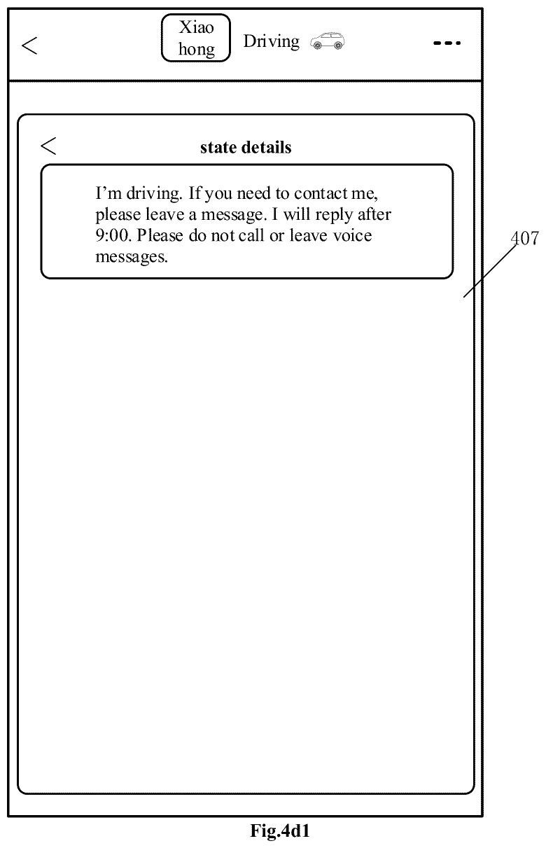

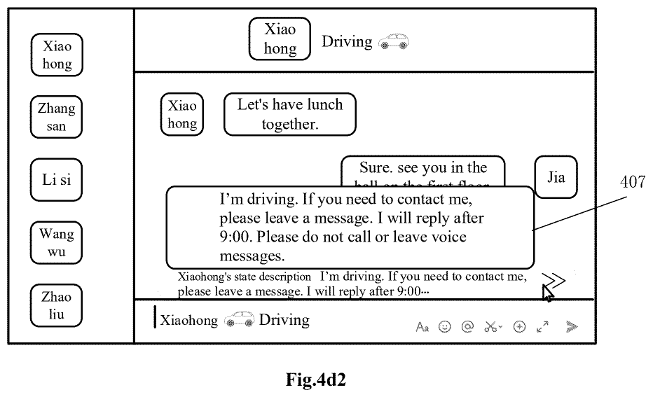

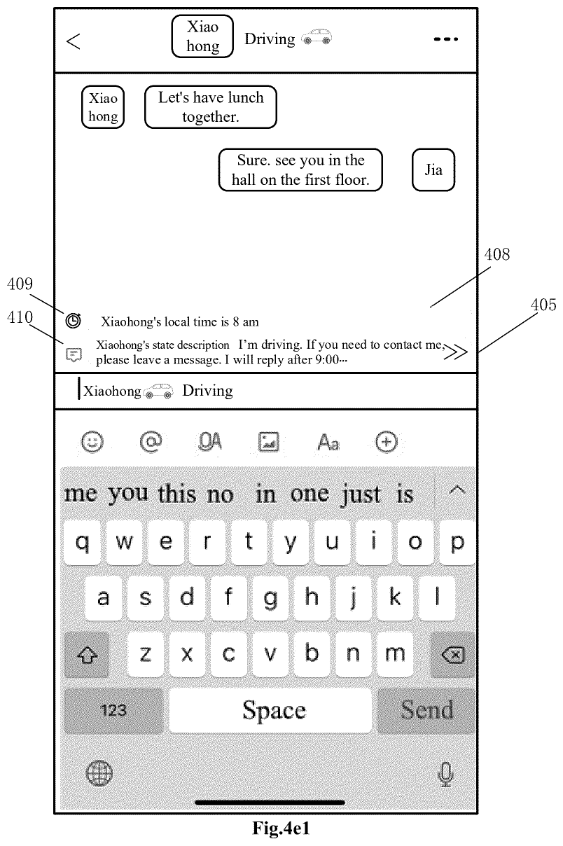

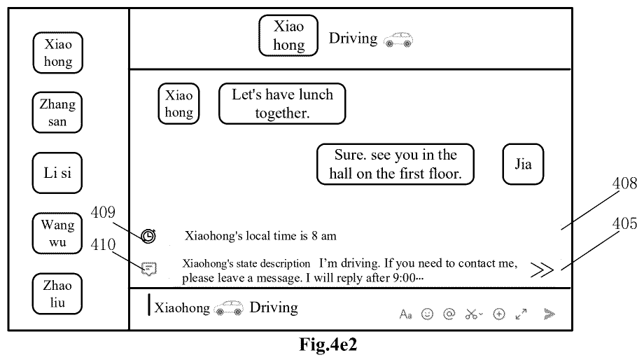

FIG. 4a1 and FIG. 4a2 are schematic diagrams of a chat interface of an instant messaging client according to an exemplary embodiment (FIG. 4a1 corresponds to a mobile terminal interface, and FIG. 4a2 corresponds to a PC terminal interface). As shown in FIG. 4a1 and FIG. 4a2, a user who logs in to the instant messaging client enters a chat interface with a friend, and if the friend is preset with a state, for example, the state is “driving”, the state may be displayed in the chat interface. For example, the state may be displayed behind the name of the friend in a top region 401 of the chat interface.

Optionally, the state may also be displayed in a message input box 402 of the chat interface. Specifically, before a message is input in the message input box, an icon 403 corresponding to the state and text content 404 corresponding to the state may be displayed in the message input box as a guidance message. For example, in a case where the message input box is not activated by the user, or in a case where the message input box is activated by the user but no message is input, the icon 403 corresponding to the state and the text content 404 corresponding to the state may be displayed in the message input box as the guidance message. As shown in FIG. 4b1 and FIG. 4b2 (FIG. 4b1 corresponds to a mobile terminal interface, and FIG. 4b2 corresponds to a PC terminal interface), after the message input box is activated by the user and the message is input, the message input by the user is displayed in the message input box, and the icon corresponding to the state and the text content corresponding to the state which are displayed before are eliminated.

In addition, the friend can preset a corresponding state description for the state, and the state description may include more additional information about the state, for example, the content of the state description may include “driving, reply to messages later”, etc. Therefore, while displaying the state, the state description corresponding to the state may also be displayed in the chat interface. For example, as shown in FIG. 4a1 and FIG. 4a2, the state description corresponding to the state may be displayed in a region 405 above the message input box in the chat interface.

It should be noted that if the content of the state description to be displayed is not long, and an area of a region required for displaying the state description is smaller than the area of the region 405, all content of the state description may be directly displayed in the region 405. As shown in FIG. 4c1 and FIG. 4c2 (FIG. 4c1 corresponds to a mobile terminal interface, and FIG. 4c2 corresponds to a PC terminal interface), if the content of the state description to be displayed is too long, for example, the content of the state description includes “I'm driving. If you need to contact me, please leave a message. I will reply after 9:00. Please do not call or leave voice messages”, and an area of the region required for displaying the state description is greater than the area of the region 405, a part of content of the state description may be displayed in the region 405, for example, “I'm driving. If you need to contact me, please leave a message. I will reply after 9:00 ...” may be displayed in the region 405. A guidance icon 406 may be displayed behind the displayed part of content of the state description to guide the user to view the full content of the state description through a triggering operation. The triggering operation may be to click the content of the state description displayed in the region 405, or to click the guidance icon 406, etc., and the specific manner of the triggering operation is not limited in this embodiment. As shown in FIG. 4d2 and FIG. 1d2 (FIG. 4d2 corresponds to a mobile terminal interface, and FIG. 1d2 corresponds to a PC terminal interface), after the user performs the triggering operation, a details page 407 may be output, and the full content of the state description is displayed in the details page 407.

Optionally, other prompt information may also be displayed above the message input box in the chat interface at the same time. For example, the prompt information may be information of standard time corresponding to the time zone where the friend is located. As shown in FIG. 4e1 and FIG. 4e2 (FIG. 4e1 corresponds to a mobile terminal interface, and FIG. 4e2 corresponds to a PC terminal interface), the state description may be displayed in the region 405 above the message input box in the chat interface, and the prompt information may be displayed in the region 408 above the region 405 at the same time. It should be noted that in FIG. 4e1 and FIG. 4e2, the prompt information is shown to be displayed above the state description, and actually, the prompt information may also be displayed below the state description. Moreover, more prompt information may also be displayed above the message input box in the chat interface, and the specific number, content, arrangement manner and arrangement order of the prompt information displayed above the message input box in the chat interface are not limited in this embodiment.

Further optionally, an icon 409 corresponding to the prompt information may also be displayed in front of the prompt information, and an icon 410 corresponding to the state description may be displayed in front of the state description, so that the user can distinguish the prompt information from the state description more conveniently and quickly through the icon 409 and the icon 410.

In the solution provided in this embodiment, after a chat interface of a friend is entered, in response to the friend being set with a target state, the target state is displayed in the chat interface, and a state description corresponding to the target state is displayed in the chat interface, where the state description is preset by the friend for the target state. This allows the user to view richer additional information preset by the friend for the target state of the friend more comprehensively without disturbing the friend, thereby expanding a function of the instant messaging client and enhancing user experience.

Further, since the user needs to activate the message input box and input a message in the message input box to send the message to the friend, displaying the target state of the friend in the message input box in the chat interface can enable the user to pay attention to the target state of the friend more conveniently and quickly, thereby providing the user with a more friendly manner of information prompting and further enhancing user experience. In addition, displaying the state description corresponding to the state above the message input box in the chat interface can also enable the user to view the additional information set by the friend for the target state of the friend more conveniently and quickly, thereby further expanding a function of the instant messaging client and enhancing user experience.

Still further, after the user performs a triggering operation for the state description, a details page is output and full content of the state description is displayed in the details page, thereby providing a more flexible manner of displaying the state description and further enhancing user experience.

Still further, if other prompt information is also displayed above the message input box in the chat interface, an icon corresponding to the prompt information is displayed in front of the prompt information, and an icon corresponding to the state description is displayed in front of the state description, so that the user can quickly distinguish the prompt information from the state description, thereby further enhancing user experience.

The present disclosure will be described in detail below with reference to specific embodiments.

FIG. 5 is a flowchart of a method for processing state information according to an exemplary embodiment. The method can be applied to a terminal device. In this embodiment, for ease of understanding, an example will be described below in combination with a terminal device on which an instant messaging client can be installed. Those skilled in the art can understand that the terminal device may include, but is not limited to, a mobile terminal device such as a smart phone and a tablet computer, a laptop computer, a desktop computer, and the like. The method may include the following steps.

As shown in FIG. 5, in step 501, in response to entering a target chat interface corresponding to a target contact, it is determined whether the target contact is set with a state.

In this embodiment, the target contact may be a contact for instant messaging selected by a user who logs in to the instant messaging client from a contact list of the instant messaging client. The user can enter the target chat interface corresponding to the target contact by performing, in the contact list of the instant messaging client, a triggering operation for the target contact. The target chat interface may be an interface for instant messaging between the user and the target contact, and the user and the target contact can send messages or make a call through the target chat interface.

After the user enters the target chat interface, the instant messaging client may first determine whether the target contact is set with a state. Specifically, in an implementation, the instant messaging client may send a state query request to a server to instruct the server to query whether the target contact is set with a state, and in response to the target contact being set with a state and the state being a target state, the target state is returned to the instant messaging client. In another implementation, after the instant messaging client is logged in by the user, a chat information set may be acquired from the server and the chat information set is continuously updated. The chat information set may include latest state information corresponding to respective contacts of the user. The instant messaging client may query, from the chat information set, whether the target contact is set with a state, and in response to the target contact being set with a state and the state being a target state, the target state is acquired from the chat information set.

In step 502, in response to the target contact being set with a target state, the target state is displayed in the target chat interface.

In this embodiment, in response to the target contact being set with a state (the state is specifically a target state, where the target state refers to a specific state), the target state may be displayed in at least one region in the target chat interface. For example, the target state may be displayed only behind the name of the target contact in the top region of the target chat interface (see FIG. 4a1 and FIG. 4a2). For another example, the target state may be displayed in a message input box of the target chat interface. For yet another example, the target state may be displayed both behind the name of the target contact in the top region of the target chat interface and in the message input box of the target chat interface.

The displaying the target state in the message input box of the target chat interface may be specifically displaying the target state in the message input box as a guidance message before a message is input in the message input box. For example, an icon corresponding to the target state may be displayed in the message input box as the guidance message, or text content corresponding to the target state may be displayed in the message input box as the guidance message, or the icon corresponding to the target state and the text content corresponding to the target state may both be displayed in the message input box as the guidance message (see FIG. 4a1 and FIG. 4a2). After the message is input, the message input is displayed in the message input box, and the target state displayed in the message input box is eliminated (see FIG. 4b1 and FIG. 4b2).

In step 503, a target state description corresponding to the target state is displayed in the target chat interface.

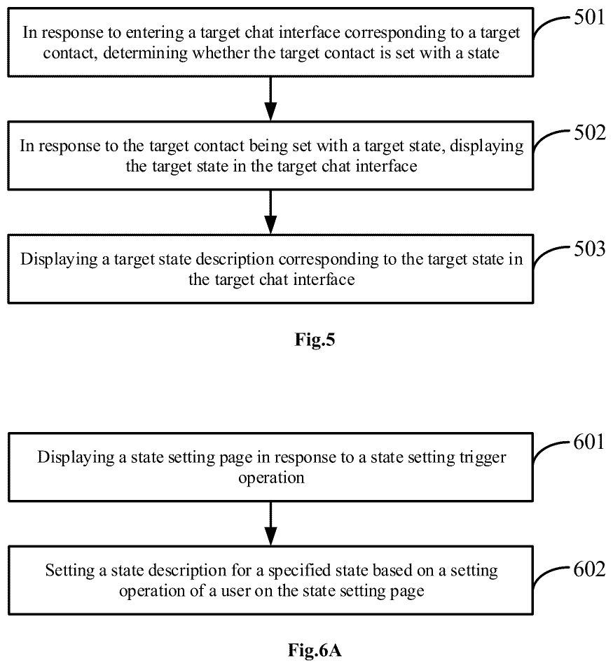

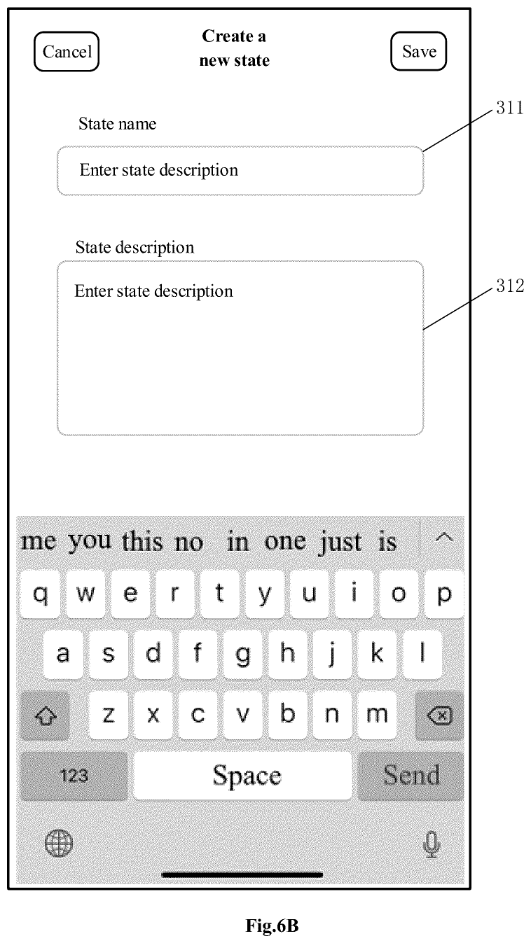

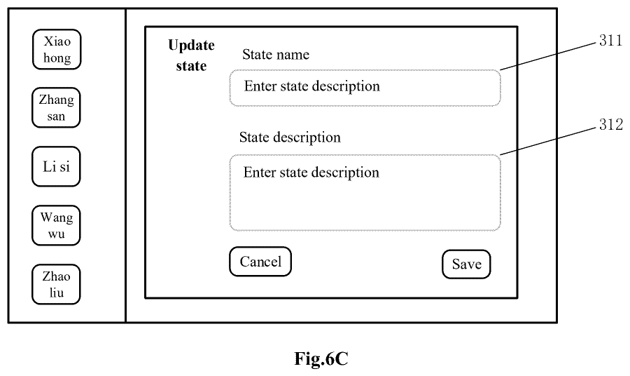

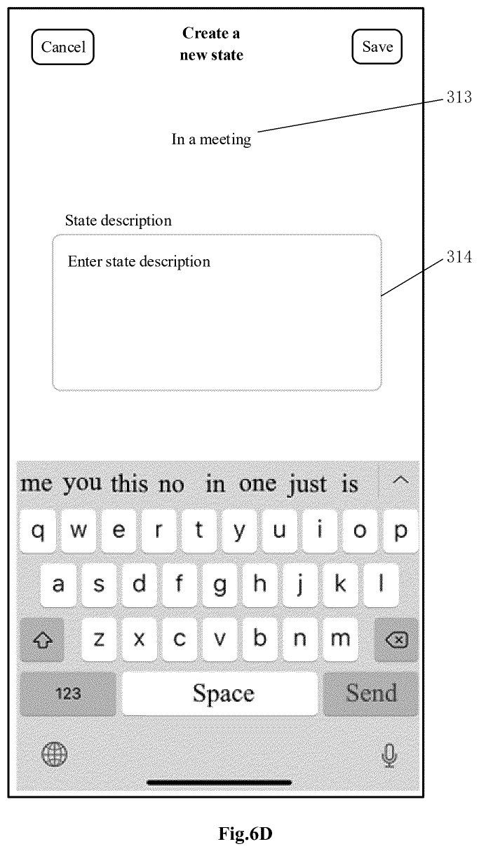

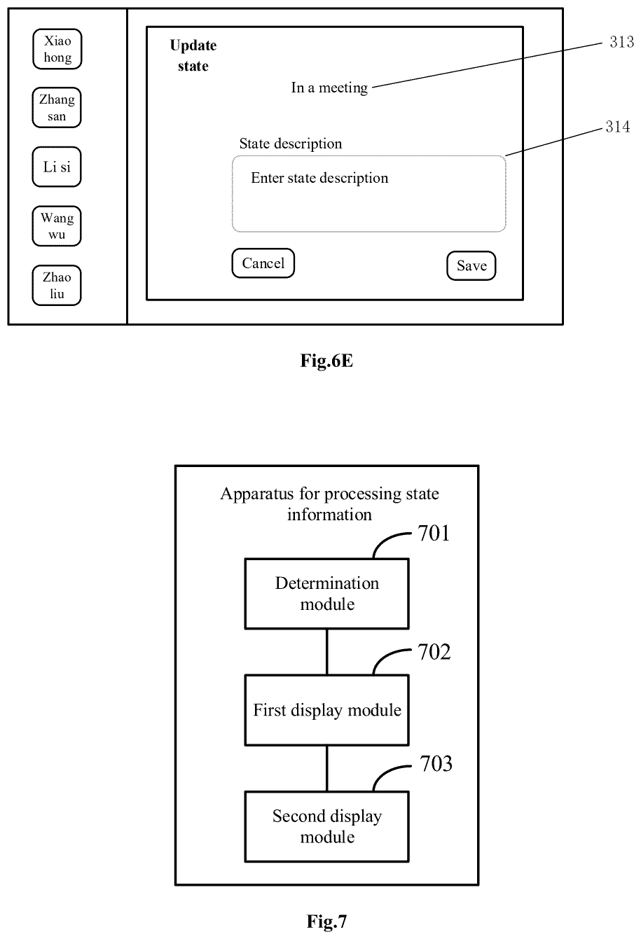

In this embodiment, the target state description is preset by the target contact for the target state (for a specific setting process, reference may be made to the embodiment in FIG. 6A), and may be a supplementary description about the target state by the target contact, including more additional information of the target state. Specifically, the target state description may be displayed in a first region above the message input box in the target chat interface (see FIG. 4a1 and FIG. 4a2). In response to an area of a region required for displaying the target state description being greater than an area of the first region, a part of content of the target state description may be displayed in the first region, and remaining content of the target state description may be hidden (see FIG. 4c1 and FIG. 4c2).

In the embodiments of the present disclosure, the user may preset different state descriptions for different states.

Optionally, in response to a triggering operation of the user for the target state description, a details page may be output, and full content of the target state description is displayed in the details page (see FIG. 4d2 and FIG. 1d2). The triggering operation may be an operation of clicking a display area of the target state description, or an operation of hovering the mouse over the display area of the target state description, etc., and the specific manner of the triggering operation is not limited in this embodiment.

Further optionally, target prompt information may also be displayed in a second region above the message input box in the target chat interface, where the target prompt information may be other prompt information other than the target state description, for example, the target prompt information may be prompt information of standard time of the time zone where the target contact is located, or may be prompt information of a task created with the target contact, or may be prompt information of an online meeting scheduled with the target contact, etc. The specific content of the target prompt information is not limited in this embodiment.

Still further optionally, a first icon indicating a category of the target prompt information is displayed in front of the target prompt information in the second region. A second icon indicating the state description is displayed in front of the target state description in the first region (see FIG. 4e1 and FIG. 4e2). The first icon and the second icon can help the user to distinguish the target prompt information from the target state description.

The present disclosure provides a method for processing state information. After a target chat interface corresponding to a target contact is entered, in response to the target contact being set with a target state, the target state is displayed in the target chat interface, and a state description corresponding to the target state is displayed in the target chat interface, where the state description is preset by the target contact for the target state. This allows the user to view richer additional information preset by the contact for the state of the contact more comprehensively without disturbing the contact, thereby enhancing user experience.

FIG. 6A is a flowchart of another method for processing state information according to an exemplary embodiment. This embodiment describes a process of setting a state description, and any user who logs in to the instant messaging client (including the target contact involved in the embodiment in FIG. 5) can set the state description through the process. The process includes the following steps.

As shown in FIG. 6A, in step 601, a state setting page is displayed in response to a state setting triggering operation; and in step 602, a state description is set for a specified state based on a setting operation of a user on the state setting page.

In this embodiment, in response to a state setting triggering operation performed by the user, a state setting page used to set different state descriptions for different states is displayed. The state setting triggering operation may be a first operation of creating a new state, or a second operation of selecting, from a plurality of alternative states, a state to be set. It should be noted that the state setting page displayed and triggered by the first operation is different from the state setting page displayed and triggered by the second operation.

FIG. 6B and FIG. 6C are schematic diagrams of a state setting page displayed and triggered by the first operation. As shown in FIG. 6B and FIG. 6C, the state setting page includes a state name input box 311 and a state description input box 312. The user can input a name of the newly created state through the state name input box 311, and input a state description of the newly created state through the state description input box 312. After the user clicks a save button, the state description input through the state description input box 312 is stored in association with the state input through the state name input box 311, thereby completing the setting of the state description of the newly created state.

FIG. 6D and FIG. 6E are schematic diagrams of a state setting page displayed and triggered by the second operation. As shown in FIG. 6D and FIG. 6E, a name of a state selected by the user from a plurality of alternative states is displayed in a region 313 of the state setting page, and the user can input a state description of the selected state through a state description input box 314. After the user clicks a save button, the state description input through the state description input box 312 is stored in association with the state displayed in the region 313, thereby completing the setting of the state description of the selected state.

In this embodiment, the user can set different state descriptions for different states, so that the state description set by the user is more targeted, thereby further expanding a function of the instant messaging client and enhancing user experience.

It should be noted that although the operations of the method of the embodiments of the present disclosure are described in a specific order in the above embodiments, this does not require or imply that these operations must be performed in this specific order, or that all the illustrated operations must be performed to achieve a desired result. Rather, the steps depicted in the flowcharts may be performed in a different order. Additionally or alternatively, some steps may be omitted, multiple steps may be combined into one step for execution, and/or one step may be decomposed into multiple steps for execution.

Corresponding to the foregoing embodiments of the method for processing state information, the present disclosure further provides embodiments of an apparatus for processing state information.

As shown in FIG. 7, FIG. 7 is a block diagram of an apparatus for processing state information according to an exemplary embodiment of the present disclosure. The apparatus may include: a determination module 701, a first display module 702, and a second display module 703.

The determination module 701 is configured to, in response to entering a target chat interface corresponding to a target contact, determine whether the target contact is set with a state.

The first display module 702 is configured to, in response to the target contact being set with a target state, display the target state in the target chat interface.

The second display module 703 is configured to, display a target state description corresponding to the target state in the target chat interface. The target state description is preset for the target state.

In some implementations, the first display module 702 is configured to: display the target state in a message input box of the target chat interface.

In some other implementations, the first display module 702 may display the target state in the message input box of the target chat interface in the following manner: before a message is input in the message input box, display the target state in the message input box as a guidance message.

In some other implementations, the first display module 702 may display the target state in the message input box as a guidance message in the following manner: display, in the message input box, an icon corresponding to the target state as the guidance message; and/or display, in the message input box, text content corresponding to the target state as the guidance message.

In some other implementations, the second display module 703 is configured to: display the target state description in a first region above the message input box in the target chat interface.

In some other implementations, the second display module 703 may display the target state description in the first region above the message input box in the target chat interface in the following manner: in response to an area of a region required for displaying the target state description being greater than an area of the first region, display a part of content of the target state description in the first region.

In some other implementations, the apparatus may further include: an output module (not shown in the figure).

The output module is configured to, in response to a triggering operation of the user for the target state description, output a details page, where full content of the target state description is displayed in the details page.

In some other implementations, the apparatus may further include: an output module (not shown in the figure).

The prompt module is configured to, display target prompt information in a second region above the message input box in the target chat interface, where the second region is above or below the first region.

In some other implementations, the apparatus may further include: a first icon display module and a second icon display module (not shown in the figure).

The first icon display module is configured to, display a first icon in front of the target prompt information in the second region.

The second icon display module is configured to, display a second icon in front of the target state description in the first region, where the first icon and the second icon are used to distinguish the target prompt information from the target state description.

In some other implementations, the apparatus may further include: a setting module (not shown in the figure).

The setting module is configured to display a state setting page in response to a state setting triggering operation, where the state setting page is used to set different state descriptions for different states.

For the apparatus embodiments, since they basically correspond to the method embodiments, reference may be made to the description of the method embodiments for relevant parts. The apparatus embodiments described above are only schematic, and the units described as separate components may be or may not be physically separated, and the components displayed as units may be or may not be physical units, that is, they may be located in one place, or may be distributed to multiple network units. Some or all of the modules may be selected according to actual needs to achieve the purpose of the solutions of the embodiments of the present disclosure. Those of ordinary skill in the art can understand and implement without paying creative efforts.

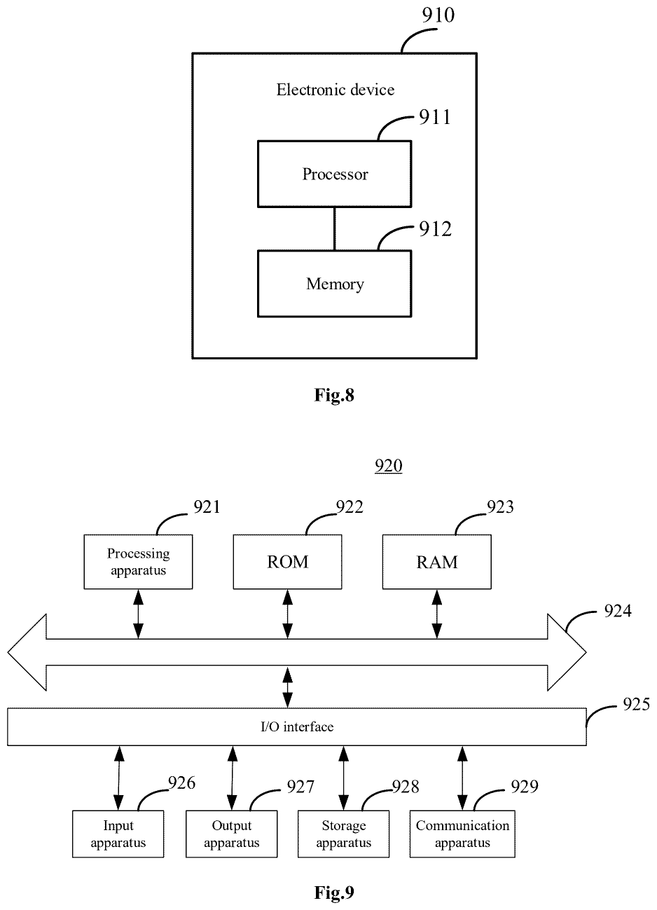

FIG. 8 is a schematic block diagram of an electronic device according to some embodiments of the present disclosure. As shown in FIG. 8, the electronic device 910 includes a processor 911 and a memory 912, which can be used to implement a client or a server. The memory 912 is configured to store computer-executable instructions (for example, one or more computer program modules) non-transiently. The processor 911 is configured to run the computer-executable instructions, and when the computer-executable instructions are run by the processor 911, one or more steps in the above-mentioned method for processing state information may be executed, thereby implementing the above-mentioned method for processing state information. The memory 912 and the processor 911 may be interconnected through a bus system and/or other forms of connection mechanisms (not shown).

For example, the processor 911 may be a central processing unit (CPU), a graphics processing unit (GPU), or other forms of processing units with data processing capabilities and/or program execution capabilities. For example, the central processing unit (CPU) may be X86 or ARM architecture, etc. The processor 911 may be a general-purpose processor or a special-purpose processor, and can control other components in the electronic device 910 to perform desired functions.

For example, the memory 912 may include any combination of one or more computer program products, and the computer program products may include various forms of computer-readable storage media, such as a volatile memory and/or a non-volatile memory. The volatile memory may include, for example, a random-access memory (RAM) and/or a cache. The non-volatile memory may include, for example, a read-only memory (ROM), a hard disk, an erasable programmable read-only memory (EPROM), a portable compact disk read-only memory (CD-ROM), a USB memory, a flash memory, etc. One or more computer program modules may be stored on the computer-readable storage medium, and the processor 911 may run the one or more computer program modules to implement various functions of the electronic device 910. Various applications and various data, as well as various data used and/or generated by the applications, etc. may also be stored in the computer-readable storage medium.

It should be noted that in the embodiments of the present disclosure, for the specific function and technical effect of the electronic device 910, reference may be made to the above description of the method for processing state information, which will not be repeated here.

FIG. 9 is a schematic block diagram of another electronic device according to some embodiments of the present disclosure. The electronic device 920 is, for example, adapted to implement the method for processing state information provided in the embodiments of the present disclosure. The electronic device 920 may be a terminal device and the like, and can be used to implement a client or a server. The electronic device 920 may include, but is not limited to, mobile terminals such as mobile phones, notebook computers, digital broadcast receivers, personal digital assistants (PDA), tablet computers, portable multimedia players (PMP), vehicle-mounted terminals (e.g., vehicle navigation terminals), wearable electronic devices, etc., and fixed terminals such as digital TVs, desktop computers, smart home devices, etc. It should be noted that the electronic device 920 shown in FIG. 9 is only an example, and will not bring any limitation to the functions and the scope of use of the embodiments of the present disclosure.

As shown in FIG. 9, the electronic device 920 may include a processing apparatus (such as a central processing unit, a graphics processing unit, etc.) 921, which can perform various appropriate actions and processes according to a program stored in a read-only memory (ROM) 922 or a program loaded from a storage apparatus 928 into a random access memory (RAM) 923. Various programs and data required for the operation of the electronic device 920 are also stored in the RAM 923. The processing apparatus 921, the ROM 922, and the RAM 923 are connected to each other through a bus 924. An input/output (I/O) interface 925 is also connected to the bus 924.

Generally, the following apparatuses may be connected to the I/O interface 925: an input apparatus 926 including, for example, a touchscreen, a touchpad, a keyboard, a mouse, a camera, a microphone, an accelerometer, a gyroscope, and the like; an output apparatus 927 including, for example, a liquid crystal display (LCD), a speaker, a vibrator, and the like; a storage apparatus 928 including, for example, a magnetic tape, a hard disk, and the like; and a communication apparatus 929. The communication apparatus 929 may allow the electronic device 920 to perform wireless or wired communication with other electronic devices to exchange data. Although FIG. 9 shows the electronic device 920 having various apparatuses, it should be understood that it is not required to implement or have all of the illustrated apparatuses, and the electronic device 920 may alternatively implement or have more or fewer apparatuses.

For example, according to the embodiments of the present disclosure, the above-mentioned method for processing state information may be implemented as a computer software program. For example, an embodiment of the present disclosure includes a computer program product, which includes a computer program carried on a non-transitory computer-readable medium, and the computer program includes program codes for executing the above-mentioned method for processing state information. In such an embodiment, the computer program may be downloaded and installed from a network through the communication apparatus 929, or installed from the storage apparatus 928, or installed from the ROM 922. When the computer program is executed by the processing apparatus 921, the functions defined in the method for processing state information provided in the embodiments of the present disclosure can be implemented.

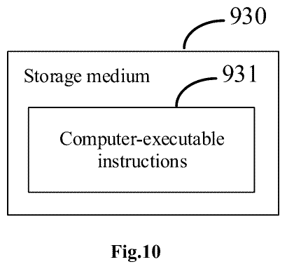

FIG. 10 is a schematic diagram of a storage medium according to some embodiments of the present disclosure. For example, as shown in FIG. 10, the storage medium 930 may be a non-transitory computer-readable storage medium, which is configured to store non-transitory computer-executable instructions 931. When the non-transitory computer-executable instructions 931 are executed by a processor, the method for processing state information according to the embodiments of the present disclosure may be implemented. For example, when the non-transitory computer-executable instructions 931 are executed by a processor, one or more steps of the method for processing state information according to the above description may be executed.

For example, the storage medium 930 may be applied to the above-mentioned electronic device. For example, the storage medium 930 may include a memory in the electronic device.

For example, the storage medium may include a memory card of a smart phone, a storage component of a tablet computer, a hard disk of a personal computer, a random-access memory (RAM), a read-only memory (ROM), an erasable programmable read-only memory (EPROM), a portable compact disk read-only memory (CD-ROM), a flash memory, or any combination of the above storage media, or may be other suitable storage media.

For example, for the description of the storage medium 930, reference may be made to the description of the memory in the embodiments of the electronic device, and the repeated parts will not be repeated. For the specific function and technical effect of the storage medium 930, reference may be made to the above description of the method for processing state information, which will not be repeated here.

It should be noted that in the context of the present disclosure, a computer-readable medium may be a tangible medium that may contain or store a program for use by or in combination with an instruction execution system, apparatus, or device. The computer-readable medium may be a computer-readable signal medium or a computer-readable storage medium or any combination thereof. The computer-readable storage medium may be, for example, but not limited to, an electrical, magnetic, optical, electromagnetic, infrared, or semiconductor system, apparatus, or device, or any combination thereof.

More specific examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, the computer-readable storage medium may be any tangible medium that contains or stores a program that may be used by or in combination with an instruction execution system, apparatus, or device. In the present disclosure, the computer-readable signal medium may include a data signal that propagates in a baseband or as part of a carrier wave and that carries computer-readable program code. The data signal propagating in such a manner may take a variety of forms, including, but not limited to, an electromagnetic signal, an optical signal, or any suitable combination of the foregoing. The computer-readable signal medium may also be any computer-readable medium other than the computer-readable storage medium. The computer-readable signal medium may send, propagate, or transmit a program for use by or in combination with an instruction execution system, apparatus, or device. The program code contained on the computer-readable medium may be transmitted by using any suitable medium, including but not limited to, an electric wire, a fiber-optic cable, radio frequency (RF) and the like, or any suitable combination of the foregoing.

Those skilled in the art will easily think of other embodiments of the present disclosure after considering the embodiments of the present disclosure. The present disclosure is intended to cover any modification, use, or adaptation of the present disclosure. These modifications, uses, or adaptations follow the general principles of the present disclosure and include common knowledge or conventional technical means in the art that are not disclosed in the present disclosure. The embodiments of the present disclosure are only considered as exemplary, and the true scope and spirit of the present disclosure are pointed out by the claims.

It should be understood that the present disclosure is not limited to the precise structure described above and shown in the drawings, and various modifications and changes can be made without departing from the scope of the present disclosure. The scope of the present disclosure is only limited by the appended claims.

1. A method for processing state information, comprising:
in response to a chat triggering operation for a chat object, determining whether the chat object is set with a state; and
in response to the chat object being set with the state, displaying the state of the chat object in a chat interface.

2. The method according to claim 1, wherein
the in response to the chat triggering operation for the chat object, determining whether the chat object is set with the state comprises:
in response to a preset operation of mentioning a first member by a user in a group chat, determining whether the first member is set with a state, wherein the chat object comprises the first member in the group chat, and the chat triggering operation comprises the preset operation of mentioning the first member by the user in the group chat; and
the in response to the chat object being set with the state, displaying the state of the chat object in the chat interface comprises:
in response to the first member being set with a first state, displaying first state information corresponding to the first member in a target region of a chat interface of the group chat.

3. The method according to claim 2, wherein the preset operation of mentioning the first member in the group chat comprises: inputting a combination of a preset character and a member identifier of the first member in a message input box of the group chat.

4. The method according to claim 3, wherein after the displaying the first state information, the method further comprises:
eliminating the first state information displayed in the target region after content in the message input box is cleared.

5. The method according to claim 2, wherein the target region is between a message input box and a chat message display region in the chat interface of the group chat.

6. The method according to claim 2, wherein
the first state information comprises the first state;
or
the first state information comprises the first state and a state description of the first member;
or
the first state information comprises the first state and a first state description corresponding to the first state, wherein the first state description is preset for the first state.

7. The method according to claim 2, wherein the displaying the first state information corresponding to the first member in the target region of the chat interface of the group chat comprises:
in response to an area of a region required for displaying the first state information being greater than an area of the target region, displaying a part of content of the first state information in the target region.

8. The method according to claim 2, further comprising:
in response to an operation of triggering the target region by the user, displaying a first details page, wherein details content of the first state information is displayed in the first details page.

9. The method according to claim 2, wherein after the displaying the first state information, the in response to the chat triggering operation for the chat object, determining whether the chat object is set with the state further comprises:
in response to a preset operation of mentioning a second member by the user in the group chat, determining whether the second member is set with a state, wherein the chat object further comprises the second member in the group chat, and the chat triggering operation further comprises the preset operation of mentioning the second member by the user in the group chat; and
the in response to the chat object being set with the state, displaying the state of the chat object in the chat interface further comprises:
in response to determining that the second member is set with a second state, updating the first state information displayed in the target region to second state information corresponding to the second member.

10. The method according to claim 9, wherein after the displaying the second state information, the method further comprises:
displaying, in the chat interface of the group chat, a guidance region in which guidance information is displayed; and
in response to triggering the guidance region by the user, displaying a second details page, wherein the second details page displays at least the first state information and the second state information.

11. The method according to claim 9, further comprising:
displaying a target icon indicating a state in front of the first state information or the second state information in the target region.

12. The method according to claim 1, wherein the in response to the chat triggering operation for the chat object, determining whether the chat object is set with the state comprises:
in response to entering a target chat interface corresponding to a target contact, determining whether the target contact is set with a state, wherein the chat object comprises the target contact, and the chat triggering operation comprises an operation of entering the target chat interface corresponding to the target contact; and
the in response to the chat object being set with the state, displaying the state of the chat object in the chat interface comprises:
in response to the target contact being set with a target state, displaying the target state in the target chat interface; and
displaying a target state description corresponding to the target state in the target chat interface, wherein the target state description is preset for the target state.

13. The method according to claim 12, wherein the displaying the target state in the target chat interface comprises: before a message is input in a message input box, displaying the target state in a message input box of the target chat interface.

14. (canceled)

15. The method according to claim 13, wherein the displaying the target state in the message input box-as comprises:
displaying, in the message input box, an icon corresponding to the target state as a guidance message; and/or
displaying, in the message input box, text content corresponding to the target state as the guidance message.

16. The method according to claim 12, wherein the displaying the target state description corresponding to the target state in the target chat interface comprises:
displaying the target state description in a first region above a message input box in the target chat interface.

17. (canceled)

18. (canceled)

19. The method according to claim 16, further comprising:
displaying target prompt information in a second region above the message input box in the target chat interface, wherein the second region is above or below the first region.

20. The method according to claim 19, further comprising:
displaying a first icon in front of the target prompt information in the second region; and
displaying a second icon in front of the target state description in the first region, wherein the first icon and the second icon are used to distinguish the target prompt information from the target state description.

21. The method according to claim 12, further comprising:
displaying a state setting page in response to a state setting triggering operation, wherein the state setting page is used to set different state descriptions for different states.

22. (canceled)

23. (canceled)

24. (canceled)

25. A non-transitory computer-readable storage medium having a computer program stored thereon, wherein the computer program, when executed by a computer, causes the computer to perform a method for processing state information, and the method comprises:
in response to a chat triggering operation for a chat object, determining whether the chat object is set with a state; and
in response to the chat object being set with the state, displaying the state of the chat object in a chat interface.

26. An electronic device, comprising a memory and a processor, wherein executable code is stored in the memory, wherein a method for processing state information is implemented when the processor executes the executable code, and the method comprises:
in response to a chat triggering operation for a chat object, determining whether the chat object is set with a state; and
in response to the chat object being set with the state, displaying the state of the chat object in a chat interface.
